(19) United States
(12) Patent Application Publication
(10) Pub. No.: US 2022/0055707 A1
(43) Pub. Date: Feb. 24, 2022

(54) Fishing Rod Holder for Bicycles

(71) Applicant: Richard A. Megica, JR., Grapevine, TX (US)

(72) Inventor: Richard A. Megica, JR., Grapevine, TX (US)

(21) Appl. No.: 17/407,762

(22) Filed: Aug. 20, 2021

Related U.S. Application Data
(60) Provisional application No. 63/068,565, filed on Aug. 21, 2020.

(51) Int. Cl. B62J 11/05

(52) U.S. Cl. CPC B62J 11/05

(57) ABSTRACT

A fishing rod holder for transporting a fishing rod on a bicycle includes a vertically-oriented tube connected to a horizontally-aligned piece that connects to a bicycle's forward left chain stay. The vertically-oriented tube holds the rod and includes a notch at the top end to prevent it from rotating in the holder. The horizontally-aligned piece includes a stop surface for locking against the nut or locking mechanism of the rear wheel, and a locking mechanism for fixing it to the chain stay.

### REFERENCE TO RELATED APPLICATIONS

This application claims priority to provisional application No. 63/068,565 and incorporates that application in its entirety.

### BACKGROUND OF THE INVENTION

The present invention solves a problem with transporting a fishing rod or pole on a bicycle without requiring the rider to hold or touch the rod. The rider's hands are frequently both needed for safe riding. Accordingly, the present invention permits a rider to safely carry a fishing rod by providing a vertically-oriented tube for holding the rod, the tube mounted to the bicycle to a horizontal member.

### BRIEF STATEMENT OF THE INVENTION

In an embodiment, the bottom portion of the rod fits through a vertically-aligned hollow tube, with the lowest part of the rod that extends vertically rests within a notch in the top end of that tube to limit horizontal movement of the rod, or movement of the rod around its long axis. Without this feature, the rod could turn and the reel could contact the wheel while in motion. The fishing rod holder includes a horizontally-aligned piece that connects with (and firmly fixed to) the bicycle's forward left chain stay, preferably with a half circle-shaped portion to wrap around the chain stay. The half circle is vertical in that drawing a line vertically from ground and up, there is half of a round circle pipe on the right, and nothing on the left. The rear portion of the apparatus is a full circle to provide support to the vertically-aligned tube.

In an embodiment, the upper end of the vertical tube has cuts, notches, cutouts, detents, on both the front/back side of the pipe. This is because the lowest portion of a fishing rod which extends vertically outside of the fishing rod can vary by fishing reel type. For example, in a “baitcasting” or “spincasting” rod/reel the lowest part vertically is a notch the opposite side of the reel, which would rest on the inside cut of the rod holder. In an “spinning” rod/reel the lowest part is the reel frame which attaches to the rod and sits on the outside part of the holder. A fly-fishing rod also sits on the outside portion.

In an embodiment, the holder includes a rod tube, aligned vertically, connected to a stay tube, aligned horizontally and connected to the rod tube. The rod tube is open down its middle and has one or more cutouts on its top end, preferably on its front and back sides. The stay tube extends to the left from the side of the rod tube, between its top and bottom ends. The stay tube is circular in section at the rod tube end and to about midway along its length, where it is cut away vertically on its back side to the end of the stay tube. The cutaway forms a half-pipe-like end portion on the stay tube. At the cutline, a stop surface is formed and a notch is cut into the back portion of that stop surface. One or more locking mechanisms is provided to fix the stay tube to a chain stay on the bicycle. The notch and stop surface are aligned axially to the left nut or locking mechanism of the rear wheel and the half-pipe portion of the stay tube placed around the chain stay. The locking mechanisms are fixed around the chain stay and stay tube, fixing the holder to the bicycle.

In an embodiment, the rod tube is formed of an upper tube fixed into a lower tube, the lower tube including a tubular elbow joint. The stay tube is joined by inserting into the tubular elbow joint and being screwed thereto.

In an embodiment, zip ties or pipe clamps with padding fix the stay tube to the chain stay by tightening around the outside of the stay tube and the chain stay.

In an embodiment, the holder includes a vertical tube, aligned vertically, formed monolithically to a horizontal tube and extending to the left. The vertical tube is open down its middle and has one or more cutouts on its top end, preferably on its front and back sides. The horizontal extends from the vertical tube about at its middle. The horizontal tube is substantially circular in section at the end near the vertical tube but forms an open semi-circular concave portion from about midway along its length to its far end. At the transition to the concave semi-circular portion, a left-facing stop surface is formed on the back side of the horizontal tube. One or more locking mechanisms is provided to fix the horizontal tube to a chain stay on the bicycle. The stop surface is aligned axially to a portion of the rear wheel assembly extending beyond the wheel bracket and the concave portion of the horizontal tube placed around the chain stay. The locking mechanisms are fixed around the chain stay and horizontal tube, fixing the holder to the bicycle.

### BRIEF DESCRIPTION OF THE FIGURES

FIG. 1 shows a top & rear isometric view of a first embodiment of the present invention.

FIG. 2 shows a bottom & front isometric view of the first embodiment.

FIG. 3 shows a rear view of the first embodiment.

FIG. 4 shows a top view of the first embodiment.

FIG. 5 shows a left side view of the first embodiment.

FIG. 6A shows a front view of the first embodiment installed on a bicycle.

FIG. 6B shows a partial section view along line A-A from FIG. 6A.

FIG. 7A shows a left side view of the first embodiment installed on a bicycle.

FIG. 7B shows a detail view of FIG. 7A.

FIG. 8 shows a top & rear isometric view of a second embodiment of the present invention.

FIG. 9 shows a rear view of the second embodiment.

FIG. 10 shows a top view of the second embodiment.

FIG. 11 shows a left side view of the second embodiment.

FIG. 12 shows a top & rear isometric view of a third embodiment of the present invention.

FIG. 13 shows a rear view of the third embodiment.

FIG. 14 shows a top view of the third d embodiment.

FIG. 15 shows a left side view of the third embodiment.

### DETAILED DESCRIPTION OF THE INVENTION

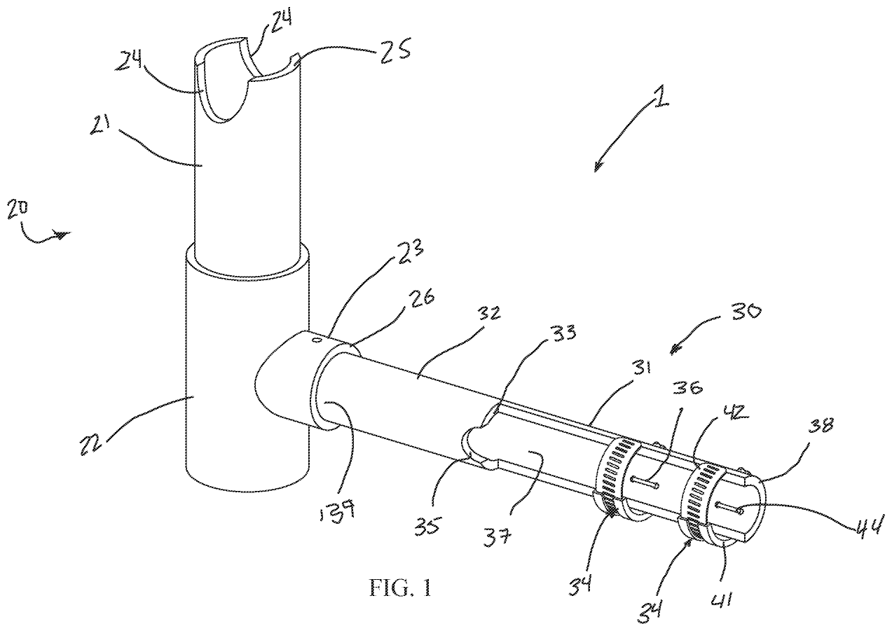

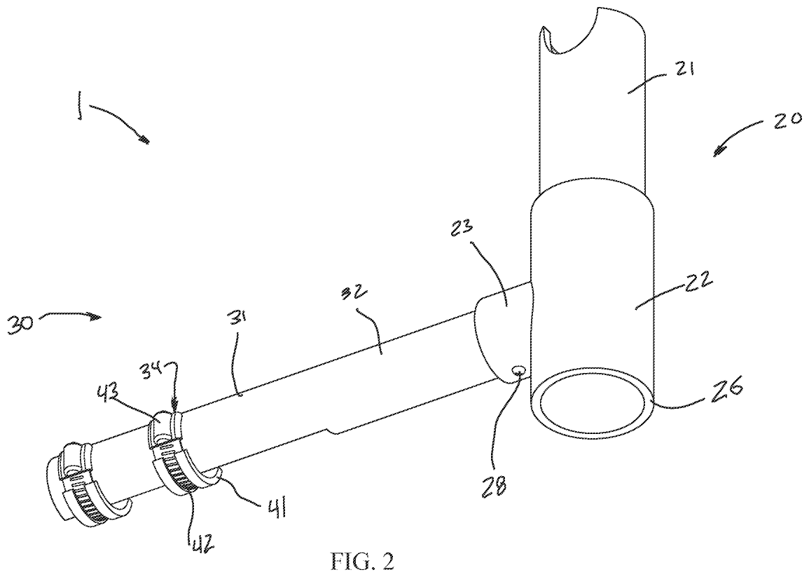

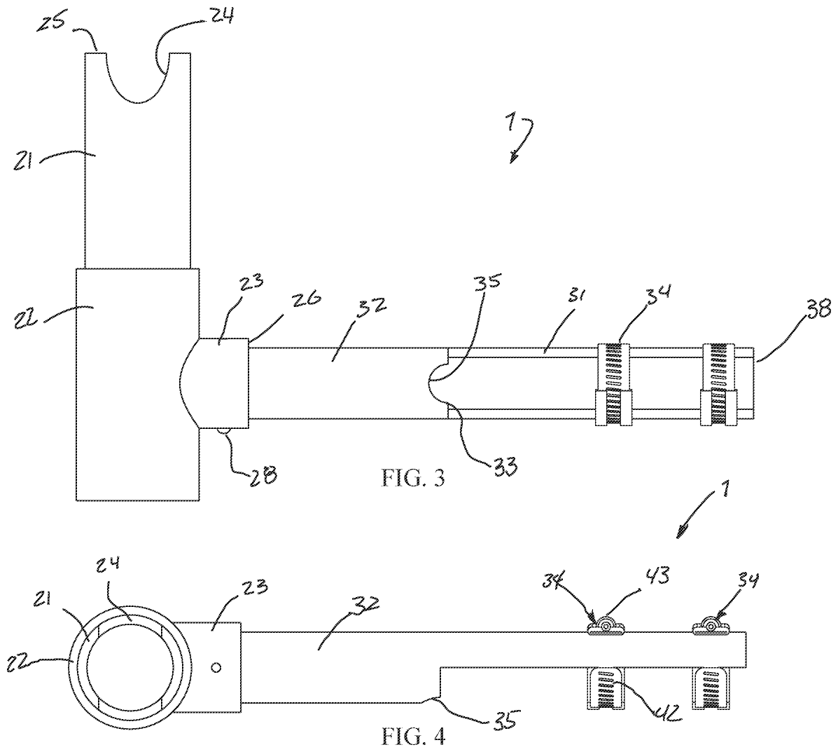

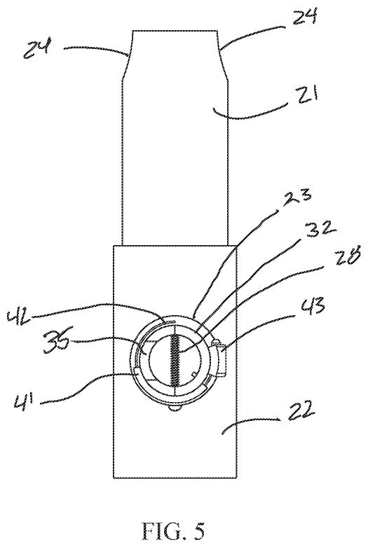

For a first embodiment, we refer to FIGS. 1-5.

Rod holder 1 includes vertical pipe 20 and horizontal pipe 30.

Vertical pipe 20 includes bottom vertical pipe 22, top vertical pipe 21. Both the vertical and horizontal pipes could be fabricated to be one piece or fabricated using separate components. Bottom vertical pipe 22 is open and defines a void that allows for rod to extend downward beyond holder 1 while rested therein, and at top for insertion of top vertical pipe 21, and includes tee connection 23 for connecting to horizontal pipe 30. Top vertical pipe 21 is open top and bottom inserted into bottom vertical pipe 22 and includes rod notches 24 formed on front and back of top 25 and permits fishing rod 70 to extend upward therefrom. Tee connection 23 includes tee end 26 and screw 28 drilled through both tee connection 23 and the free end of full pipe rear extension 32 to prevent vertical pipe 20 from rotating about tee connection 23. Rod notches 24 limit rotation of fishing rod 70 in holder 1, and are two cuts into the top end of vertical pipe 21, one on the bicycle side and the other on the other side. The lowest portion of the cuts are approximately 180 degrees from each other. The purpose is to allow reel 71 of fishing rod 70 to settle into one of notch 24 to prevent the fishing rod from rotating horizontally which if it did could cause the protruding reel to make contact with a rotating bicycle wheel.

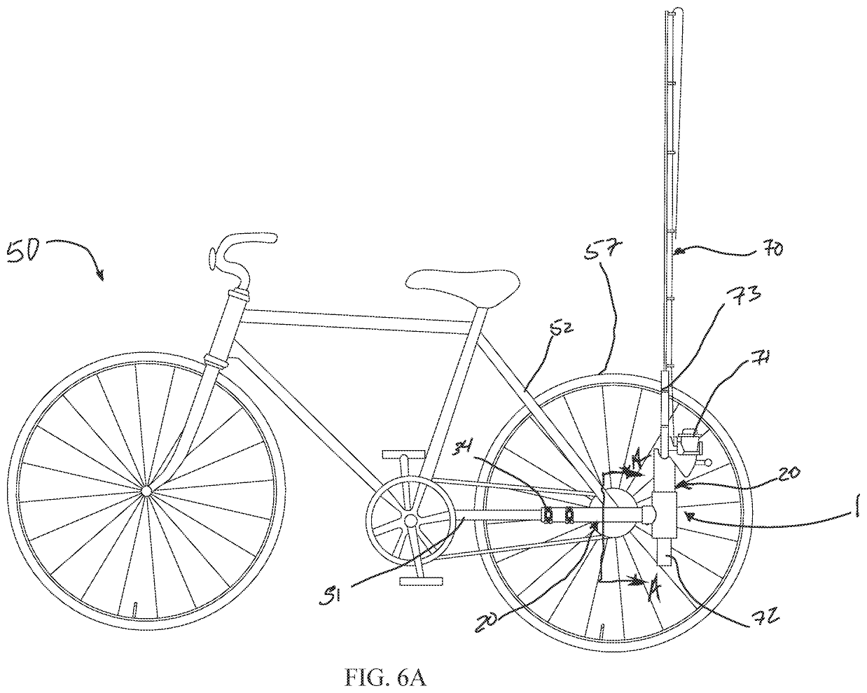

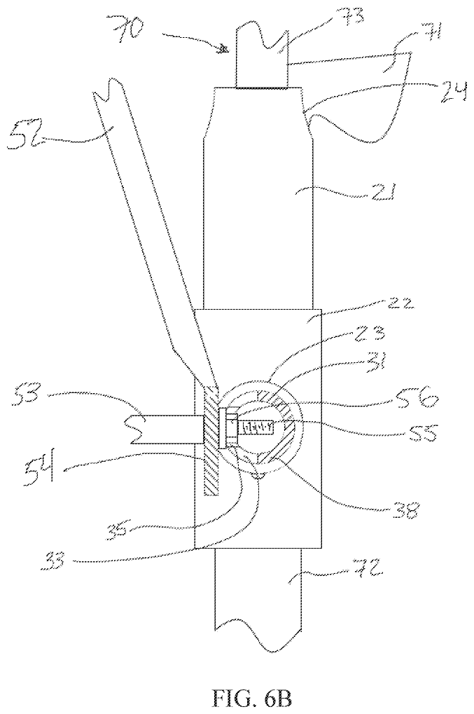

Horizontal pipe 30 includes half-pipe securing section 31, full-pipe rear extension 32, half-circle cut out 33, and chain stay clamps 34. Half-pipe securing section 31 to is used to mount rod holder 1 securely to rear horizontal chain stay 51 on the left side of bicycle 50. As mounted (see FIGS. 6A-6B), securing section 31 sits along chain stay 51, forward of the hub assembly, hub 53, axle 55, and axle nut 56. Securing section 31 is formed as a half-pipe shape with the concave section facing rearwardly (toward bicycle 50) forming stay cavity 37, and the convex side facing forwardly. The near end adjoins half-circle cutout 33. Far end 38 is free but chain stay clamps 34 are fixed near that far end. Full-pipe rear extension 32 is used to support vertical pipe 20 rearwardly from the hub assembly, allowing a rider space to swing their leg over the bicycle frame or seat to mount the bicycle without their leg hitting the fishing rod. The near end of rear extension 32 is inserted into tee end 26 and fixed with screw 28. The far end adjoins half-circle cutout 33.

Half-circle cut out 33 is a left-facing stopping structure (rearward relative to the bicycle) designed to engage with and wrap around half of the rear wheel nut which aids in attaching the wheel to the frame. Cut out 33 forms the transition between full-pipe rear extension 32 and half-pipe securing section 31 and may be formed by cutting away half of a pipe to form them both, and leaving the left-facing surface. Cut out 33 also includes nut notch 35 formed as a substantially semi-circular detent extending into rear extension 32. This half circle is not visible when looking at the holder horizontally from the front of the bicycle to the rear of the bicycle at the same elevation as the holder. The half circle which wraps around the tire nut is located on the inside portion of the mount which attaches to the chain stay.

Chain stay clamps 34 are clamping structures set roughly two inches apart near far end 38 of securing section 31 to fix securing section 31 to chain stay 51. This is to limit or eliminate movement of rod holder 1 in any direction. Clamps 34 include pipe clamp tongue 42, screw tightener 43, and elastomeric rubber inseam pad 41. Clamps 34 can open a space between tongue 42 and tightener 43 allowing it to be wrapped over chain stay 51. Rubber inseam 41 provides friction to secure securing section 31 to chain stay 51 when tongue 42 is inserted into tightener 43 and then tightened. Clamps 34 are secured to securing section 31, e.g. by zip ties 36 via a hole drilled through securing section 31 approximately 2 mm outside the width of clamp 36, then zip tie 36 wraps around clamp 34 and pipe together, and is tightened.

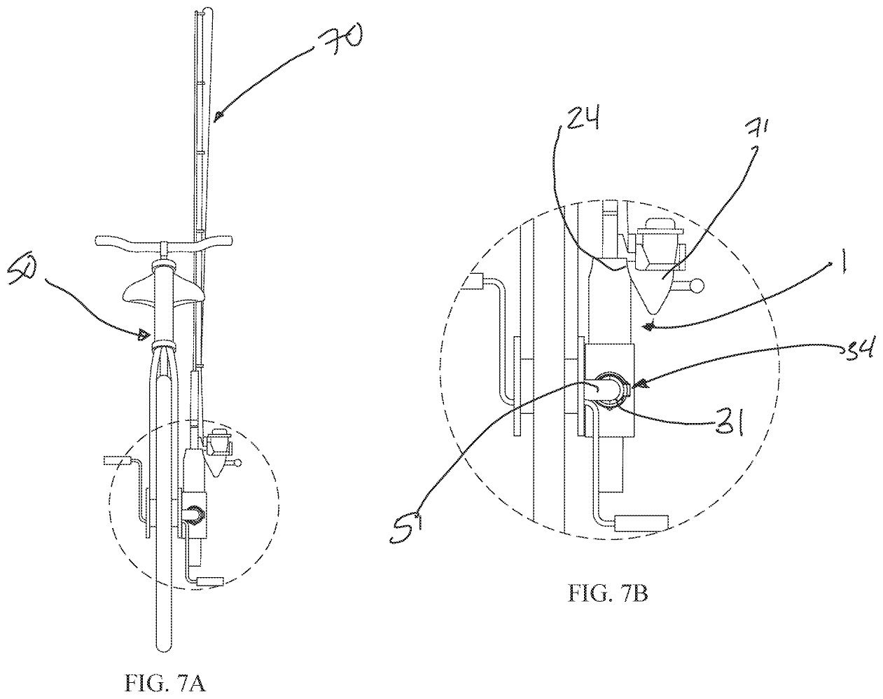

To show mounting of an embodiment, we refer to FIGS. 6A-7B.

Bicycle 50 includes rear wheel 57, chain stay 51 and seat stay 52 connected by bracket 54 connecting the two and forming a mounting surface for wheel 56. Bicycle wheel 57 includes hub 53 radially central thereto and threaded axle 55 extending outwardly to both sides therefrom. Wheel 57 attaches to bracket 54 between chain stay 51 and seat stay 52 via axle 55. Axle 55 is, at each horizontal end thereof, threaded to engage axle nut 56 and secure wheel 57 to bracket 54, thus axle nut 56 is secured, axially compressing against bracket 54 and should not move. Chain stay 51 is a portion of the main frame of bicycle 50 that attaches to seat stay 52 on the rear end of bicycle 50 at bracket 54, and to a down tube on the front end of bicycle 50. Chain stay 51 is typically tubular in formation, and may be circular in outer profile, or substantially circular, or have another rounded or oval profile. Seat stay 52 is a portion of the main frame of bicycle 50 that attaches to a seat tube at its upper/front end and chain stay 51 at its lower/rear end, via bracket 54.

Fishing rod or pole 70 includes mounting section 73 for mounting reel 71 and having butt end 72 at the far end thereof, and supporting a flexible rod at the near end of mounting section 73.

Holder 1 is mounted by fixing securing section 31 to and along chain stay 51. Securing section 31 is situated forward of hub 53, axle 55, and axle nut 56. Cut out 33 is engaged to axle 55 or axle nut 56 by pushing it leftward (forward on the bicycle) thereagainst, preferably engaging axle nut 56 in nut notch 35. This permits rear extension 32 to extend rightward (rearward on the bicycle) behind the hub assembly to support vertical tube 20 in position out of the rider's way. Chain stay is situated at least partly within stay cavity 37 and clamps 34 are applied to tightly secure securing section 31 to chain stay 51. The compressive force of clamps 34 holds them together, and holds axle nut 56 in nut notch 55, preventing rotation about the long axis of horizontal section 30, and thereby supports vertical pipe 20 in position to support fishing rod 70 in a secure vertical position.

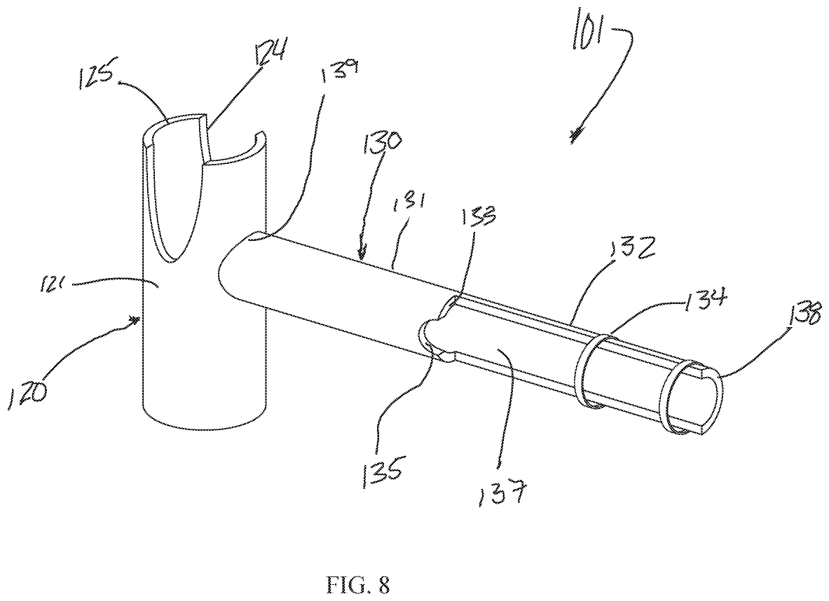

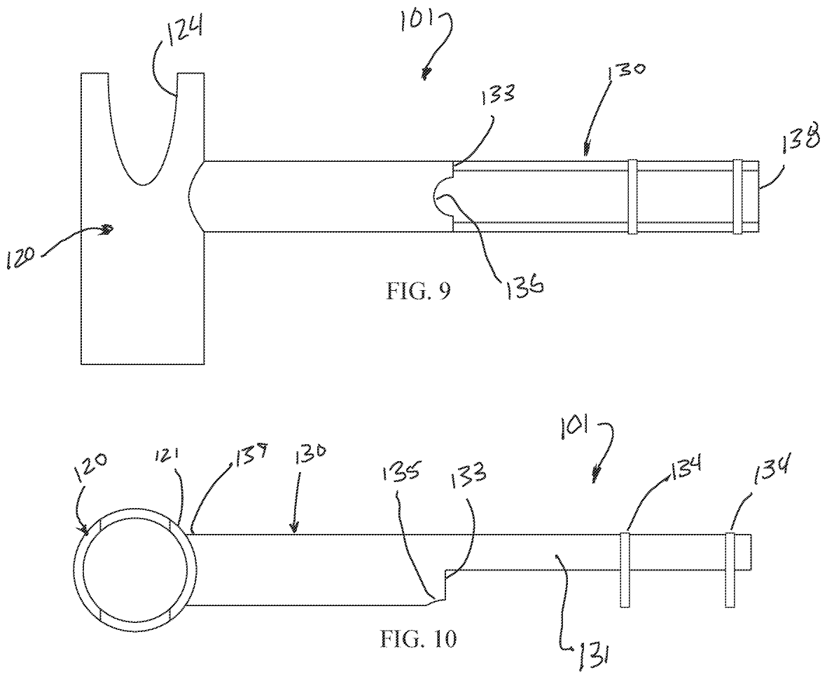

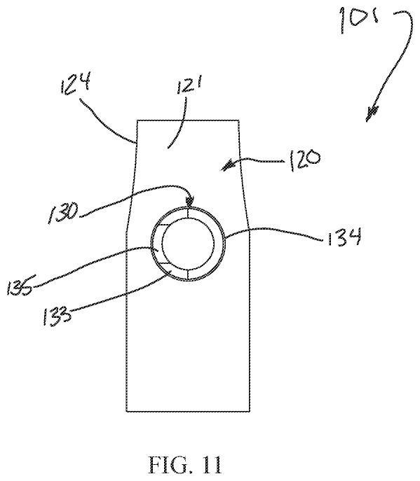

For a second embodiment, we refer to FIGS. 8-11.

Fishing rod mount 101 includes rod tube 120 and crosspiece 130.

Rod tube 120 includes tube 121, which is open and allows for butt end 72 to extend downward beyond mount 101 while rested therein, and at top 125 for insertion of fishing rod 70 (e.g. as in FIGS. 6A-7B). Tube 121 includes reel notches 124 formed on front and back of top 125 and permitting reel 71 of fishing rod 70 settle therein and limit rotation of rod 70.

Crosspiece 130 includes open clamping section 131, tubular rear extension 132, rear-facing stop 133, and clamping mechanisms 134. Clamping section 131 is used to fix mount 101 securely to chain stay 51 on the left side of bicycle 50. As mounted (e.g. in FIGS. 6A-6B), clamping section 131 sits along chain stay 51, forward of the hub assembly, hub 53, axle 55, and axle nut 56. Clamping section 131 is formed as an open partially circular with the concave section facing rearwardly (toward bicycle 50) forming cavity 137, and the convex side facing forwardly. The near end adjoins rear-facing stop 133. Far end 138 is free but clamping mechanisms 134 are fixed near that far end. Rear extension 132 is tubular, e.g. for strength and to form stop 133, and is used to support rod tube 120 rearwardly from the hub assembly, allowing a rider space to swing their leg over the bicycle frame or seat to mount the bicycle without their leg hitting the fishing rod. Near end 139 of rear extension 132 is joined to tube 121. The far end adjoins stop 133.

Crosspiece 130 may be joined to rod tube 120 by plastic or metal welding, adhesive, or other joining processes, or the pieces may be formed monolithically, e.g. by molding or additive manufacturing processes. The joinder of crosspiece 130 and rod tube 120 prevents rod tube 120 from rotating relative to crosspiece 130.

Rear-facing stop 133 is a left-facing stop (rearward relative to the bicycle) to engage with part of the bicycle rear wheel assembly to limit travel forward and rotation. Stop 133 forms the transition between rear extension 132 and clamping section 131 where the closed tubular section of rear extension 132 changes to the open convex partial circle of clamping section 131. Stop 133 also includes detent 135 formed substantially semi-circularly extending into rear extension 132.

Clamping mechanisms 134 are spaced apart near far end 138 of clamping section 131 to fix it to chain stay 51 (e.g. as in FIG. 6A). This is to limit or eliminate movement of mount 101 in any direction.

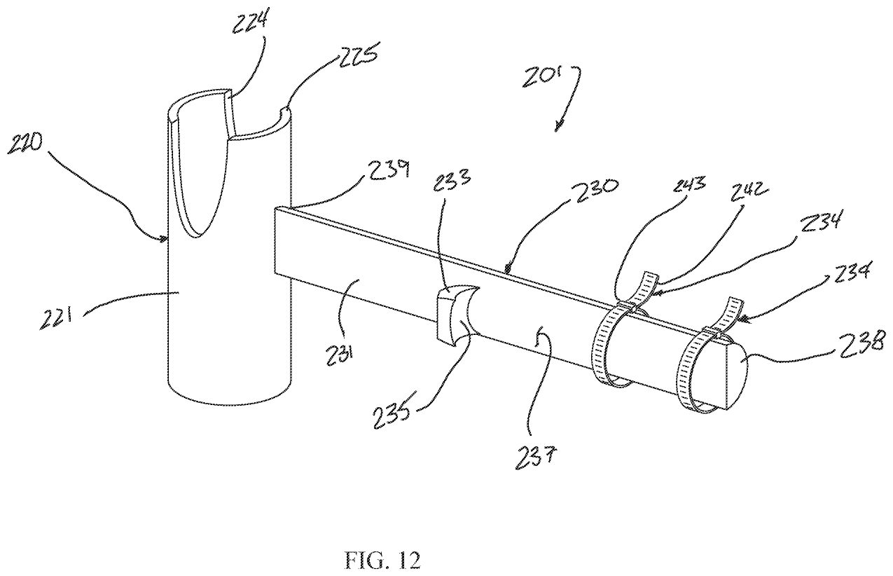

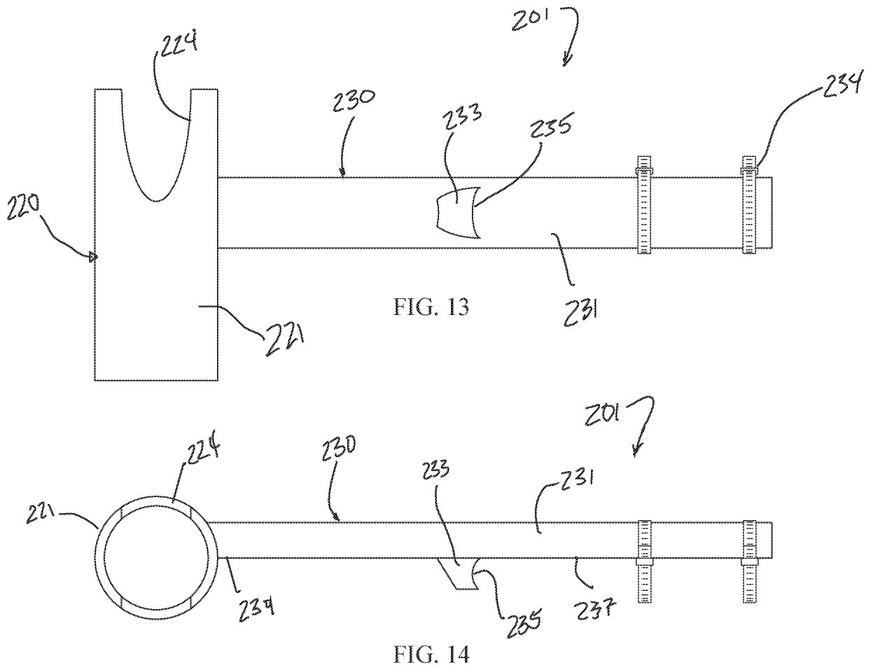

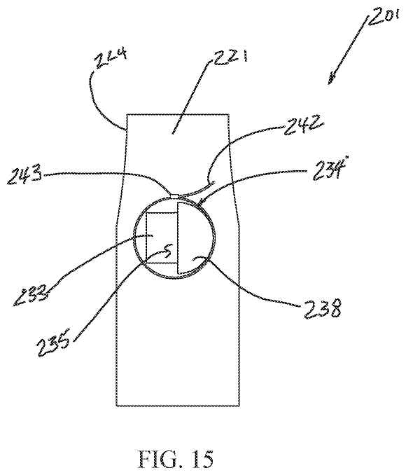

For a third embodiment, we refer to FIGS. 12-15.

Fishing rod mount 201 includes rod tube 220 and supporting arm 230.

Rod tube 220 includes tube 221, which is open and allows for butt end 72 to extend downward beyond mount 201 while rested therein, and at top 225 for insertion of fishing rod 70 (e.g. as in FIGS. 6A-7B). Tube 221 includes cutouts 224 formed on front and back of top 225 and permitting reel 71 of fishing rod 70 settle therein and limit rotation of rod 70.

Supporting arm 230 includes locking section 231, extension 232, stop 233, and zip ties 234. Both locking section 231 and extension 232 are semi-circular in section (as shown at end 238), with the flat side to the rear (toward the bicycle). In other embodiments (not shown) that section could be square, rectangular (with a long vertical axis), crescent-shaped, or partially convex to the rear. Locking section 231 is used to fix mount 201 securely to chain stay 51 on the left side of bicycle 50. As mounted (e.g. in FIGS. 6A-6B), locking section 231 sits along chain stay 51, forward of the hub assembly, hub 53, axle 55, and axle nut 56. At least some portion of flat rear face 237 of locking section 231 engages with chain stay 51.

Extension 232 extends rightward from locking section 231 to connect to and support rod tube 221 rearwardly from the hub assembly, allowing a rider space to swing their leg over the bicycle frame or seat to mount the bicycle without their leg hitting the fishing rod. Far end 238 is free but zip ties 234 are fixed near that far end.

Supporting arm 230 may be joined to rod tube 220 by plastic or metal welding, adhesive, or other joining processes, or the pieces may be formed monolithically, e.g. by molding or additive manufacturing processes. The joinder of supporting arm 230 and rod tube 220 prevents rod tube 220 from rotating relative to supporting arm 230.

Supporting arm 230 also supports stop 233 on rear face 237. Stop 233 is a tab or protrusion left-facing (rearward relative to the bicycle) to engage with part of the bicycle rear wheel assembly to limit travel forward and rotation. Stop 233 extends rearwardly from rear face 237 (toward to the bicycle) and is fixed thereto. Stop 233 includes convex face 235, facing leftward toward end 238.

Zip ties 234 are spaced apart near far end 238 of locking section 231 to fix it to chain stay 51 (e.g. as in FIG. 6A). This is to limit or eliminate movement of mount 201 in any direction. Zip ties 234 include tongue 242 for locking engagement in lock 243 about locking section 231 and chain stay 51.

In another embodiment (not shown), rod tube 220 may be replaced with a vertical bar joined to supporting arm 230, where the vertical bar includes an upper ring support and a lower ring support, preferably one above and one below the connection to supporting arm 230. The ring supports extend forwardly (away from the bicycle) and include a detent in the ring to allow reel 71 settle into a desired stable position. In another embodiment (not shown) the ring supports are angled downwards to form a stable position for reel 71.

For mounting, stop 233 is engaged to an axle or axle nut by pushing it leftward (forward on the bicycle) thereagainst, preferably engaging an axle nut securely against convex face 235. This permits extension 232 to extend rightward (rearward on the bicycle) behind the hub assembly to support rod 220 in position out of the rider's way. A chain stay is situated at least partly against rear face 237 and zip ties 234 are applied to tightly secure locking section 231 to the chain stay. The compressive force of zip ties 234 holds them together and holds the axle nut in detent 255, preventing rotation about the long axis of supporting arm 230, and thereby supports rod tube 220 in position to support fishing rod 70 in a secure vertical position.

1. A fishing rod mount, comprising:
a vertically-aligned rod tube;
a horizontally-aligned stay tube; and
a joint between the rod tube and the stay tube to prevent rotation relative therebetween;
the rod tube defining a vertical void configured to accept a fishing rod; and
the stay tube comprising:
one or more locking mechanisms on near the end opposing the rod tube, and
a stopping structure on one side thereof between the one or more locking mechanisms and the joint.

2. The mount of claim 1, the stay tube further comprising:
a circular extension connecting the stay tube to the joint; and
a half-pipe section supporting the one or more locking mechanisms.

3. The mount of claim 2, the stopping structure connecting the circular extension and the half-pipe section.

4. The mount of claim 2, the stopping structure comprising:
a stopping surface facing away from the rod tube; and
a detent formed in said stopping surface.

5. The mount of claim 1,
the rod tube comprising a tee connection; and
the joint comprising an end of the stay tube fixed within the tee connection.

6. The mount of claim 1, the rod tube further comprising one or more notches formed into a top end of the rod tube.

7. The mount of claim 1, the one or more locking mechanisms being selected from the following: zip ties and pipe clamps.

8. A fishing rod mount, comprising:
a rod tube; and
a supporting arm;
the rod tube and supporting arm connected at about a right angle at a first end of the supporting arm; and
the rod tube configured to engage a bicycle chain stay and including a locking mechanism near a second end of the supporting arm.

9. The mount of claim 8, the rod tube comprising:
a top open end; and
a pair of opposing notches on the top open end.

10. The mount of claim 8,
the supporting arm comprising a tubular extension and a convex open section;
the tubular extension connected to the rod tube; and
the locking mechanism mounted on the open section.

11. The mount of claim 8,
the supporting arm comprising a solid section having a convex face; and
the locking mechanisms mounted on the solid section.

12. The mount of claim 8, the supporting arm comprising a rear-facing stopping structure between the locking mechanism and the first end of the supporting arm.

13. The mount of claim 12,
the supporting arm comprising a tubular section and half-pipe section; and
the stopping structure forming a transition between the tubular section and the half-pipe section.

14. The mount of claim 12,
the stopping structure comprising a tab extending from the supporting arm; and
the tab comprising a convex face facing away from the rod tube.
